(19) United States
(12) Patent Application Publication
(10) Pub. No.: US 2010/0143639 A1
(43) Pub. Date: Jun. 10, 2010

(54) OUTDOOR ELECTRICAL DEVICE WITH AN IMPROVED RESIN INSULATION SYSTEM

(75) Inventors: Hoan D. Le, Wendell (CN); Steve A. Shaw, Greenville, NC (US)

Correspondence Address: ABB INC.;LEGAL DEPARTMENT-4U6, 29801 EUCLID AVENUE, WICKLIFFE, OH, 44092, US

(73) Assignee: ABB Technology AG, Zurich (CH)

(21) Appl. No.: 12/595,537

(22) PCT Filed: Apr. 4, 2008
(86) PCT No.: PCT/US08/04445

§ 371 Date: Feb. 12, 2010

(30) Foreign Application Priority Data
Apr. 12, 2007 (US) 60911417

(51) Int. Cl. B32B 1/06; B05D 3/00; C08J 5/00; B29C 39/12; B29C 39/10

(52) U.S. Cl. 428/76; 427/58; 264/331.11; 264/162; 264/255

(57) ABSTRACT

An electrical apparatus is provided that has an electrical device encapsulated in a plastic encasement. The encasement includes an inner shell and an outer shell. The inner shell has a thickness greater than the outer shell and the inner shell is more flexible than the outer shell. The inner shell is formed from a first resin composition that, when cured, has a tensile elongation at break of greater than 5% and the outer shell is formed from a second resin composition that, when cured, has a tensile elongation at break of less than 5%.

### BACKGROUND OF THE INVENTION

This invention relates to electrical devices and more particularly to an outdoor electrical device having a dry-type construction with solid insulation.

An outdoor electrical device (such as a transformer) having a dry-type construction includes at least one electrical component (such as a core/coil assembly) encapsulated in a solid insulating material to insulate and seal the electrical component from the outside environment. Conventionally, the electrical component is encapsulated in a single casting resin that is formulated to meet all electrical, chemical and thermal requirements for insulating the electrical device during its operation. In addition, this single casting resin is formulated to withstand harsh outdoor environmental conditions to preserve its insulating properties and maintain an aesthetic appearance. Typically, the single casting resin is an epoxy resin. An example of an epoxy resin especially formulated for use as a single casting resin is disclosed in U.S. Pat. No. 5,939,472 to Ito et al., which is hereby incorporated by reference.

Since a single casting resin is required to meet so many different requirements, the single casting resin is typically quite expensive to produce. In addition, the single casting resin does not provide the most optimum overall characteristics. In the past, a few electrical devices have used multiple resins in their construction. An example of an electrical device using multiple resins is an embedded vacuum interrupter having a current sensor, which is manufactured by ABB Calor Emag Mittelspannung GmbH of Ratingen, Germany. The insulation system in this embedded vacuum interrupter was developed to reduce partial discharge and has an inner layer composed of a rigid bisphenol A-based epoxy resin and an outer layer composed of a rigid cycloaliphatic epoxy resin. Another example of an electrical device using multiple resins is disclosed in U.S. Pat. No. 5,656,984 to Paradis et al. The Paradis et al. patent discloses a transformer having a silicone foam rubber (closed cell) sheet material wrapped around a metal core. The wrapped core and a coil are encapsulated in a body composed of Araldite CW229, which is a rigid epoxy resin. The foam rubber sheet material helps protect the core when the epoxy resin cures and shrinks. An outer casing composed of fiberglass is disposed around the body of epoxy resin.

Based on the foregoing, there is a need for an insulation system for an electrical device, wherein the insulation system has improved insulating and wear properties and is cost effective to produce. The present invention is directed toward an electrical device having such an insulation system and method of making such a device.

### SUMMARY OF THE INVENTION

In accordance with the present invention, an electrical apparatus and a method of forming the same are provided. The electrical apparatus includes an electrical device encapsulated in a plastic encasement. The encasement has an inner shell and an outer shell. The inner shell has a thickness greater than the outer shell and the inner shell is more flexible than the outer shell. The inner shell comprises a cured first resin composition having a tensile elongation at break of greater than 5% and the outer shell comprises a cured second resin composition having a tensile elongation at break of less than 5%.

### BRIEF DESCRIPTION OF THE DRAWINGS

The features, aspects, and advantages of the present invention will become better understood with regard to the following description, appended claims, and accompanying drawings where:

FIG. 1 is a schematic sectional view of a transformer embodied in accordance with the present invention; and

FIG. 2 is a schematic view of an inner shell of the transformer being formed in a mold.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

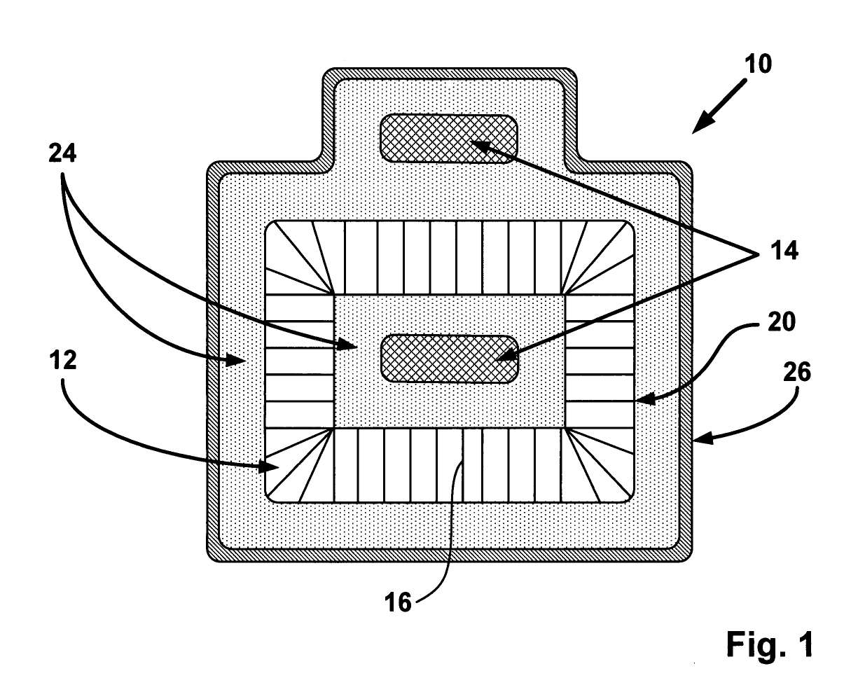

Referring now to FIG. 1, there is shown a schematic sectional view of an electrical device 10 constructed in accordance with the present invention. The electrical device 10 is an instrument transformer adapted for exterior use. More specifically, the electrical device is a current transformer. Instrument transformers are used in measurement and protective applications, together with equipment, such as meters and relays. An instrument transformer “steps down” the current or voltage of a system to a standardized value that can be handled by associated equipment. For example, a current instrument transformer may step down current in a range of 10 to 2,500 amps to a current in a range of 1 to 5 amps, while a voltage instrument transformer may step down voltage in a range of 12,000 to 40,000 volts to a voltage in a range of 100 to 120 volts.

The electrical device 10 generally comprises a core 12, a primary or high voltage winding 14, a secondary or low voltage winding 16 and an encasement 18 formed from a plurality of resins, as will be described more fully below. The core 12, the high voltage winding 14 and the low voltage winding 16 are cast into the resins so as to be encapsulated within the encasement 18.

The core 12 has an enlarged central opening and is composed of a ferromagnetic material, such as iron or steel. The core 12 may have a rectangular shape (as shown) or a torroidal or annular shape The core 12 may be comprised of a strip of steel (such as grain-oriented silicon steel), which is wound on a mandrel into a coil. Alternately, the core 12 may be formed from a stack or stacks of rectangular plates. The low voltage winding 16 comprises a length of wire, such as copper wire, wrapped around the core 12 to form a plurality of turns that are disposed around the circumference of the core 12. End portions of the low voltage winding 16 are secured to low voltage transformer leads (or form the low voltage transformer leads), which are connected to a terminal board mounted to the exterior of the encasement 18. The high voltage winding 14 is connected to high voltage transformer leads (not shown). The combination of the core 12 and the low voltage winding 16 is hereinafter referred to as the core/coil assembly 20. The high voltage winding 14 may be rectangular, torroidal or annular in shape and is interlinked with the core/coil assembly 20. The high voltage winding is composed of a conductive metal, such as copper.

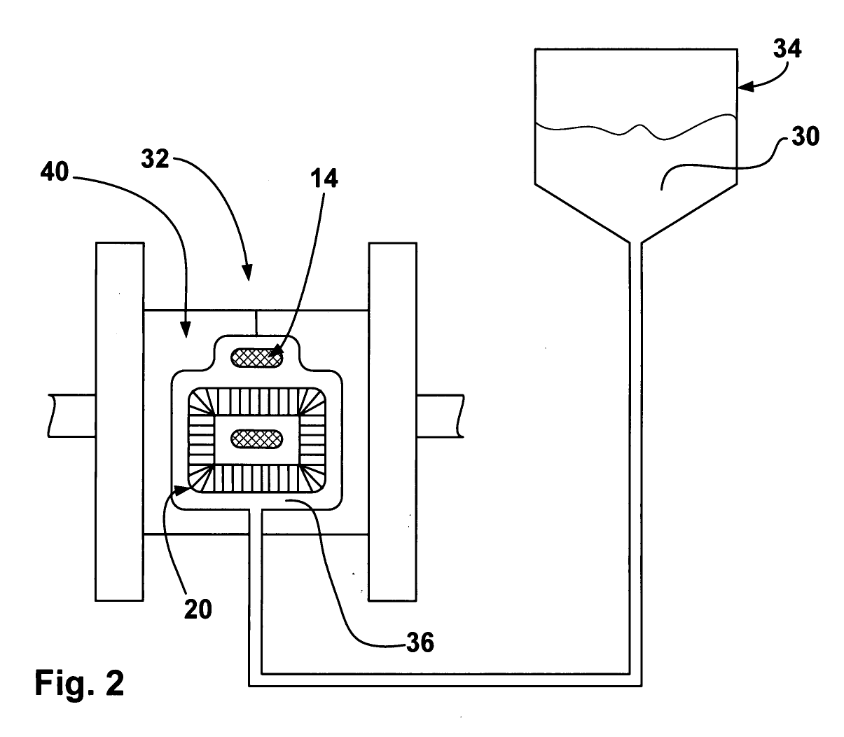

The encasement 18 comprises an inner layer or shell 24 and an outer layer or shell 26. The outer shell 26 is disposed over the inner shell 24 and is coextensive therewith. At any given point on the encasement 18, the thickness of the inner shell 24 is greater than the thickness of the outer shell 26. More particularly, the inner shell 24 has a thickness that is at least 25%, more particularly at least 50%, still more particularly at least 100% greater than the thickness of the outer shell 26. In one embodiment of the present invention, the inner shell 24 has a thickness that is about 300% greater than the thickness of the outer shell 26. The inner shell 24 is more flexible (softer) than the outer shell 26, with the inner shell 24 being comprised of a flexible first resin composition 30 (shown in FIG. 2), while the outer shell 26 being comprised of a rigid second resin composition. The first resin composition 30 (when fully cured) is flexible, having a tensile elongation at break (as measured by ASTM D638) of greater than 5%, more particularly, greater than 10%, still more particularly, greater than 20%, even still more particularly, in a range from about 20% to about 100%. The second resin composition (when fully cured) is rigid, having a tensile elongation at break (as measured by ASTM D638) of less than 5%, more particularly, in a range from about 1% to about 5%.

The first resin composition 30 of the inner shell 24 may be a flexible epoxy composition, a flexible aromatic polyurethane composition, butyl rubber, or a thermoplastic rubber.

A suitable flexible epoxy composition that may be used for the first resin composition 30 of the inner shell 24 may be formed from an epoxy resin, one or more flexibilizers and one or more curing agents (or cross-linking agent).

The epoxy resin comprises a polynuclear dihydroxy phenol (a bisphenol) and a halohydrin. Bisphenols which may be used include bisphenol A, bisphenol F, bisphenol S and 4,4′-dihydroxybisphenol. Bisphenol A has been found to be particularly suitable. The halohydrins include epichlorohydrin, dichlorohydrin and 1,2-dichloro 3-hydroxypropane. Epichlorohydrin has been found to be particularly suitable. Typically, excess molar equivalents of the epichlorohydrin are reacted with the bishphenol-A so that up to two moles of epichlorohydrin react with one mole of bishphenol-A.

The flexibilizer may react with the epoxy resin to become part of the cross-linked structure. Such a reactive flexibilizer may be a diglycidyl ether of a polyalkylene oxide or glycol, which may be formed from the reaction product of epichlorohydrin and a polyalkylene glycol, such as the ethylene and propylene oxide adducts of C₂ to C₄ polyols. Commercially-available reactive flexibilizers which may be used include D.E.R. 732, which is sold by the Dow Chemical Company of Midland, Mich. and which is a reaction product of epichlorohydrin and polypropylene glycol.

The curing agent may be an aliphatic polyamine or adduct thereof, an aromatic polyamine, an acid anhydride, a polyamide, a phenolic resin, or a catalytic type of curing agent. Suitable aliphatic polyamines include diethylene triamine (DETA), triethylene tetramine (TETA) and tetraethylene pentamine (TEPA). Suitable aromatic polyamines include metaphenylene diamine, diamino diphenyl sulfone and diethyltoluene diamine. Suitable acid anhydrides include dodecenyl succinic anhydride, hexahydrophthalic anhydride, methyl hexahydrophthalic anhydride, trimellitic anhydride, phthalic anhydride, tetrahydrophthalic anhydride, methyl tetrahydrophthallic anhydride and nadic methyl anhydride.

A suitable flexible aromatic polyurethane composition that may be used for the first resin composition 30 of the inner shell 24 is formed from a polyol, a polyisocyanate, a chain extender and optionally a catalyst. The polyol is a low molecular weight (400-10,000) hydroxyl-containing molecule with two or more hydroxyl groups per chain. The polyol may be a polyester polyol, a polycaprolactone polyol or a polyether polyol. Examples of polyester polyols include poly(ethylene adipate) and poly(1,4-butylene adipate). Examples of polyether polyols include polypropylene ether polyols and polytetramethylene ether glycols (PTMEG). The polyisocyanate may be the 2, 4 or 2,6 isomer of toluene diisocyanate (TDI), 4,4′-methylene diphenyldiisocyanate (MDI), 1,5-naphthalene diisocyanate (NDI), tolidine diisocyanate (TODD, or p-phenyl diisocyanate (PPDI), or combinations thereof. The chain extender may be an amine and/or a short chain polyol. The amine may be methylene bis(2-chloroaniline) (MCBA) or a mono-tertiary-alkyltoluenediamine, such as mono-tertiary-butyltoluenediamine. Suitable short chain polyols include ethylene glycol, propylene glycol, butane diol and glycerol. The catalyst may be used to speed up the reaction of the polyol, the polyisocyanate and the chain extender. The catalyst may be an organic metal compound or a tertiary amine, such as triethylamine.

The flexible aromatic polyurethane composition may be formed in a one-shot process or a two-step prepolymer process. The one-shot process is a single step process in which the polyol, the polyisocyanate, the chain extender and any catalyst are mixed together in a dispensing nozzle and immediately injected into a mold. The two-step prepolymer process has a first step in which an excess amount of the polyisocyanate is reacted with the polyol to form an isocyanate-terminated precursor or prepolymer. The prepolymer typically has an isocyanate (NCO) content of between about 0.5 to about 30% by weight. In a second step, the prepolymer is reacted with the chain extender and any catalyst. An additional amount of the polyisocyanate may also be added in the second step. The mixture from the second step is then added to a mold and allowed to cure.

In one particular embodiment of the present invention, the flexible aromatic polyurethane composition comprises a polyurethane system designated NB2858-91, which is produced by the Loctite Corporation. NB2858-91 is a 100% solids, two-part polyurethane system. When cured, NB2858-91 has (at 23° C.), a cured density of 1.62 gm/cc, an initial Shore D hardness of 70-75 and after 10 seconds, a Shore D hardness of 55-60, an elongation of 90%, a thermal conductivity (cal×cm)/(sec×cm²×° C.) of 18.1 and a dielectric strength (@ 20 mil thickness, volts/mil) of 1200.

A suitable thermoplastic rubber that may be used for the first resin composition 30 of the inner shell 24 may be an ethylene-propylene copolymer elastomer or terpolymer elastomer that is blended with polyethylene or polypropylene. Another suitable thermoplastic rubber may be a block copolymer having blocks of polystyrene and blocks of polybutadiene or polyisoprene.

The second resin composition of the outer shell 26 is a cycloaliphatic epoxy composition, which comprises a cycloaliphatic epoxy resin, a curing agent, an accelerator and, optionally, filler, such as silanised quartz powder, fused silica powder, or silanised fused silica powder.

The cycloaliphatic epoxy resin may be a polyglycidy ether or poly(β-methylglycidal)ether formed by the reaction of epichlorohydrin or β-methylepichlorohydrin with a compound containing two or more free alcoholic and/or phenolic hydroxyl groups per molecule. Examples of suitable cycloaliphatic epoxy resins include: bis(4-hydroxycyclohexyl)methanediglycidyl ether, 2,2-bis(4-hydroxycyclohexyl)propanediglycidyl ether, tetrahydrophthalic acid diglycidyl ester, 4-methyltetrahydrophthalic acid diglycidyl ester, 4-methylhexahydrophthalic acid diglycidyl ester, hexahydrophthalic acid diglycidyl ester, and 3,4-epoxycyclohexylmethyl 3′,4′-epoxycyclohexanecarboxylate, which is commercially available from The Dow Chemical Company under the tradename ERL-4221.

The curing agent may be an anhydride, such as a linear aliphatic polymeric anhydride, or a cyclic carboxylic anhydride. Suitable cyclic carboxylic anhydrides include: succinic anhydride, citraconic anhydride, itaconic anhydride, maleic anhydride, tricarballylic anhydride, methyl-tetrahydrophthalic anhydride, tetrahydrophthalic anhydride, hexahydrophthalic anhydride and methyl hexahydrophthalic anhydride.

The accelerator may be an amine, an acidic catalyst (such as stannous octoate), an imidazole, or a quaternary ammonium hydroxide or halide. Particularly suitable accelerators are tertiary amines, such as: N,N-dimethylbenzylamine, triethylamine, N,N-dimethylaniline, N-methylmorpholine, N-ethylmorpholine, imidazole and tetrachloromethyl ethylene amine, tetramethyl guanidine, triisopropylamine, pyridine, piperazine, triethylamine, tributylamine, dimethyl benzylamine, triphenyl amine, tricyclohexylamine, quinoline, triethylamines, triphenylamine, tri(2,3-dimethyl cyclohexyl)amine, benzyldimethylamine, 1,3-tetramethyl butane diamine, tris(dimethylaminomethyl) phenol, and triethylenediamine.

In order to improve the weatherability of the outer shell 26, the cycloaliphatic epoxy composition may further include one or more of an OH-terminated polysiloxane, a cyclic polysiloxane and a non-ionic, fluoroaliphatic surface active reagent, as is disclosed in U.S. Pat. No. 6,764,616 to Beisele et al, which is hereby incorporated by reference.

In one particular embodiment of the present invention, the cycloaliphatic epoxy composition comprises components commercially available from the Huntsman Corporation of The Woodlands, Texas, namely ARALDITE® CY 5622 resin, ARADUR® HY 1235 hardener and DY 062 accelerator. ARALDITE® CY 5622 resin is a diglycidylester, ARADUR® HY 1235 is an anhydride and DY 062 is a tertiary amine.

The encasement 18 is formed over the core/coil assembly 20 using first and second casting processes. In the first casting process, the inner shell 24 is formed from the first resin composition 30 in a mold. The components of the first resin composition 30 are first pre-heated to about 40° C. to about 60° C. and mixed together by hand or machine to form a homogeneous mixture, which is then dispensed into the mold. If the first resin composition 30 is a flexible epoxy composition, the first casting process may be an automatic pressure gelation (APG) process, or a vacuum casting process. If the first resin composition 30 is a flexible aromatic polyurethane composition, the first casting process may be an open casting process or a vacuum casting process, each of which is conducted at a temperature of from about 40° C. to about 85° C.

Referring now to FIG. 2, there is shown an APG system which may be used to form the inner shell 24. The first resin composition 30 (in liquid or semi-liquid form) is degassed under vacuum in a vessel 34, while being maintained at a temperature of from about 40° C. to about 60° C. The core/coil assembly 20 and the high voltage winding 14 are placed in a cavity 36 of a mold 40, which is heated to a temperature of from about 120 to about 160° C. The high voltage and low voltage transformer leads extend out of the cavity 36 so as to protrude from the encasement 18 after the casting process. The degassed and preheated first resin composition 30 is then introduced under slight pressure into the cavity 36 containing the core/coil assembly 20 and the high voltage winding 14. Inside the cavity 36, the first resin composition 30 quickly starts to gel. The first resin composition 30 in the cavity 36, however, remains in contact with the pressurized first resin composition 30 being introduced from the vessel 34. In this manner, the shrinkage of the gelled first resin composition 30 in the cavity 36 is compensated for by subsequent further addition of degassed and preheated first resin composition 30 entering the cavity 36 under pressure.

In an open casting process, the first resin composition 30 is simply poured into an open mold containing the core/coil assembly 20 and the high voltage winding 14. The mold is heated to a temperature of from about 40° C. to about 85° C. (for the flexible aromatic polyurethane composition).

In vacuum casting, the core/coil assembly 20 and the high voltage winding 14 are disposed in a mold enclosed in a vacuum chamber or casing. The components of the first resin composition 30 are mixed together under vacuum and introduced into the mold in the vacuum chamber, which is also under vacuum. The mold is heated to a temperature of from about 40° C. to about 85° C. for the flexible aromatic polyurethane composition, or from about 80° C. to about 100° C. for the flexible epoxy composition. After the resin is dispensed into the mold, the pressure in the vacuum chamber is raised to atmospheric pressure.

After the first resin composition 30 (the inner shell 24) cures for a period of time to form a solid, the inner shell 24 with the core/coil assembly 20 and the high voltage winding 14 enclosed therein is removed from the mold. The inner shell 24 of this intermediate product is then allowed to fully cure. After the inner shell 24 of the intermediate product is cured, the inner shell 24 is sand-blasted or otherwise roughened to promote adhesion of the second resin composition in the second casting process.

The second casting process is an APG process (such as may be performed by the APG system 32) or a vacuum casting process. In the second casting process, the intermediate product comprising the core/coil assembly 20 and the high voltage winding 14 is placed in a second mold. The second resin composition is then introduced into the second mold, which is heated to a temperature of from about 130° C. to about 150° C. for an APG process or from about 80° C. to about 100° C. for a vacuum casting process. After the second resin composition (the outer shell 26) cures for a period of time to form a solid, the encasement 18 with the core/coil assembly 20 and the high voltage winding 14 enclosed therein is removed from the second mold. The outer shell 26 is then allowed to fully cure.

In lieu of forming the encasement 18 in the foregoing manner, the encasement 18 may be formed by forming the outer shell 26 first and then using the outer shell 26 as a mold for molding the inner shell 24 over the core/coil assembly 20 and the high voltage winding 14. More specifically, the second resin composition is molded to form the outer shell 26 in two pieces and is not fully cured, i.e., the second resin composition remains reactive. The core/coil assembly 20 and the high voltage winding 14 are then placed inside the reactive outer shell 26 and then the first resin composition 30 is injected into the reactive outer shell 26. The reactive outer shell 26 is heated to a curing temperature of the first resin composition 30, which is from about 40° C. to about 85° C. if the first resin composition 30 is a flexible aromatic polyurethane composition. This elevated curing temperature also further promotes the curing of the second resin composition and chemical bonding between the first and second resin compositions.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

1. An electrical apparatus adapted for exterior use, comprising:
an electrical device; and
a plastic encasement encapsulating the electrical device, the encasement comprising an inner shell and an outer shell, the inner shell having a thickness greater than the outer shell and the inner shell being more flexible than the outer shell, the inner shell being comprised of a cured first resin composition having a tensile elongation at break of greater than 5% and the outer shell being comprised of a cured second resin composition having a tensile elongation at break of less than 5%; and
wherein the cured first resin composition is selected from the group consisting of a polyurethane resin composition, an epoxy resin composition, a thermoplastic rubber and butyl rubber.

2. The electrical apparatus of claim 1, wherein the cured first resin composition has a tensile elongation at break of greater than 10%.

3. The electrical apparatus of claim 2, wherein the electrical apparatus is a transformer and the electrical device comprises a core/coil assembly.

4. The electrical apparatus of claim 1, wherein the cured first resin composition is a polyurethane resin composition, or an epoxy resin composition.

5. The electrical apparatus of claim 4, wherein the cured second resin composition is an epoxy resin composition.

6. The electrical apparatus of claim 5, wherein the cured first resin composition is an aromatic epoxy resin composition and the cured second resin composition is a cycloaliphatic epoxy resin composition.

7. The electrical apparatus of claim 5, wherein the cured first resin composition is an aromatic polyurethane composition and the cured second resin composition is a cycloaliphatic epoxy resin composition.

8. The electrical apparatus of claim 7, wherein the inner shell has a thickness that is at least 50% greater than the thickness of the outer shell.

9. The electrical apparatus of claim 8, wherein the electrical apparatus is a transformer and the electrical device comprises a core/coil assembly.

10. A method of forming an electrical apparatus adapted for exterior use, comprising:
providing an electrical device; and
encapsulating the electrical device in a plastic encasement comprising an inner shell and an outer shell, the inner shell having a thickness greater than the outer shell and the inner shell being more flexible than the outer shell, the inner shell being comprised of a cured first resin composition having a tensile elongation at break of greater than 5% and the outer shell being comprised of a cured second resin composition having a tensile elongation at break of less than 5%; and
wherein the cured first resin composition is selected from the group consisting of a polyurethane resin composition, an epoxy resin composition, a thermoplastic rubber and butyl rubber.

11. The method of claim 10, wherein the step of encapsulating the electrical device comprises:
placing the electrical device in a mold;
dispensing the first resin composition into the mold so as to encapsulate the electrical device;
at least partially curing the first resin composition; and
removing the electrical device encapsulated in the at least partially cured first resin composition from the mold.

12. The method of claim 11, wherein the step of encapsulating the electrical device further comprises
curing the first resin composition outside of the mold, thereby forming the inner shell;
roughening the outside surface of the inner shell;
placing the inner shell with the roughened outside surface in a second mold;
dispensing the second resin composition into the second mold so as to encapsulate the inner shell with the electrical device disposed therein;
at least partially curing the second resin composition; and
removing the electrical device encapsulated in the inner shell and the at least partially cured second resin composition from the second mold.

13. The method of claim 11, wherein the step of encapsulating the electrical device further comprises:
dispensing the second resin composition into a first mold;
partially curing the second resin composition; and
removing the partially-cured second resin composition from the first mold, the partially-cured second resin composition comprising the mold within which the first resin composition is dispensed.

14. The method of claim 11, wherein the electrical apparatus is a transformer and the electrical device comprises a core/coil assembly.

15. The method of claim 14, wherein the cured first resin composition has a tensile elongation at break of greater than 10%.

16. The method of claim 19, wherein the cured first resin composition is an aromatic polyurethane composition and the cured second resin composition is a cycloaliphatic epoxy resin composition.

17. The method of claim 19, wherein the cured first resin composition is an aromatic epoxy resin composition and the cured second resin composition is a cycloaliphatic resin composition.

18. The method of claim 10, wherein the step of encapsulating the electrical device is performed such that the inner shell has a thickness that is at least 50% greater than the thickness of the outer shell.

19. The method of claim 10, wherein the cured second resin composition is an epoxy resin composition, and wherein the cured first resin composition is a polyurethane resin composition or an epoxy resin composition.
